(19) United States
(12) Patent Application Publication
(10) Pub. No.: US 2016/0144708 A1
(43) Pub. Date: May 26, 2016

(54) LUGGAGE SCOOTER

(71) Applicant: CHIOU-YANN LEE, PINGTUNG COUNTY (TW)

(72) Inventor: CHIOU-YANN LEE, PINGTUNG COUNTY (TW)

(21) Appl. No.: 14/718,382

(22) Filed: May 21, 2015

(30) Foreign Application Priority Data
Nov. 26, 2014 (TW) 103220975

(51) Int. Cl. B60K 7/00; B62K 15/00; B62K 23/02; B62D 51/02

(52) U.S. Cl. CPC B60K 7/0007; B62D 51/02; B62K 15/00; B62K 23/02; B62K 2015/005; B62K 15/008; B62K 2202/00

(57) ABSTRACT

A luggage scooter is revealed. A moveable and foldable foot rest unit is disposed on a front surface of a box. A vertical rod arranged with a handle is connected to a front end of the foot rest unit. A front wheel is set on bottom of the vertical rod while a transmission wheel is disposed on a bottom side of the box and connected to a power source. Anti-tip wheels are arranged at bottom surface of the box. The foot rest unit and the vertical rod are mounted in the box so that the luggage scooter is used as a luggage for loading objects. While being used as a scooter, the foot rest unit is extended and users sit on the box with feet stepping thereon and hands holding the handle. A drive unit drives the power source to move the transmission wheel.

### BACKGROUND OF THE INVENTION

1. Fields of the Invention

The present invention relates to a luggage scooter, especially to a luggage scooter that is not only foldable into a luggage form but also driven by users to move.

2. Descriptions of Related Art

While not in use, the foldable electric scooter is folded into a compact size for portability. However, in practice, besides high cost and complicated foldable structure, the electric scooter still have problems of large volume and heavy weight after being folded. This reduces the frequency of use in a short or long-distance movement. Moreover, the foldable electric scooter doesn't provide a storage function. Thus users need to take a backpack or a handbag while driving the foldable electric scooter. This causes inconvenience and potential danger to the user while driving the foldable electric scooter.

### SUMMARY OF THE INVENTION

Therefore it is a primary object of the present invention to provide a luggage scooter that is able to be folded into a luggage or used as a scooter driven by users. As a luggage, users can load their objects in a box of the luggage scooter and carry the objects with them conveniently. While users want to drive the luggage scooter for movement, a foot rest unit is extended from the box. Then users can sit on the box, step on the foot rest unit and hold a handle. By a drive unit on the handle that drives a power source to move, users can ride the luggage scooter.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of an embodiment according to the present invention;

FIG. 2 is a rear perspective view of an embodiment according to the present invention;

FIG. 3 is a schematic drawing showing a folded foot rest unit of an embodiment according to the present invention;

FIG. 4 is a schematic drawing showing an embodiment in use according to the present invention;

FIG. 5 is a schematic drawing showing an extended foot rest unit of an embodiment according to the present invention;

FIG. 6 is a schematic drawing showing another embodiment in use according to the present invention;

FIG. 7 is a schematic drawing showing set-up of a tent of an embodiment according to the present invention.

### DETAILED DESCRIPTION OF THE PREFERRED EMBODIMENT

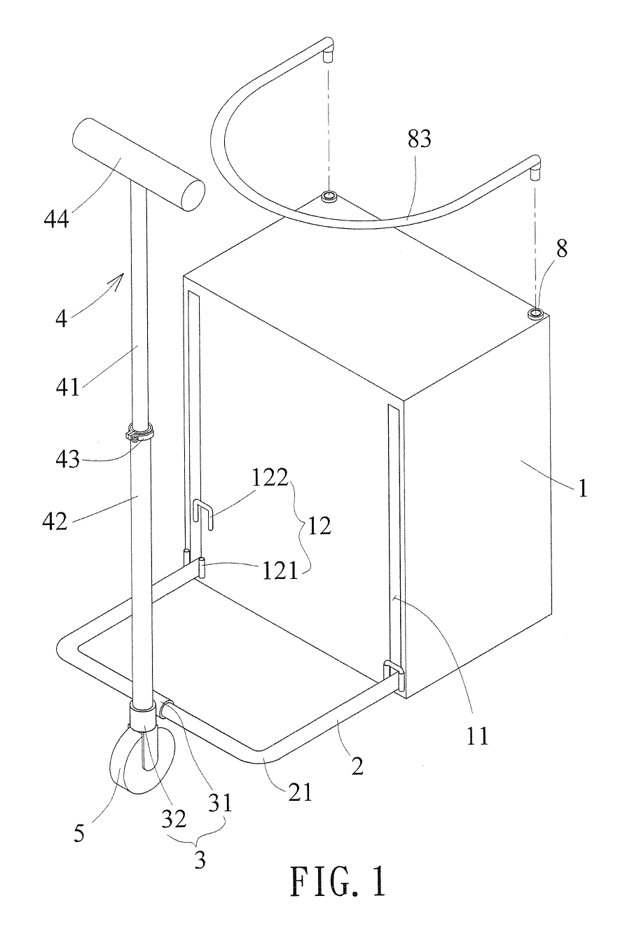

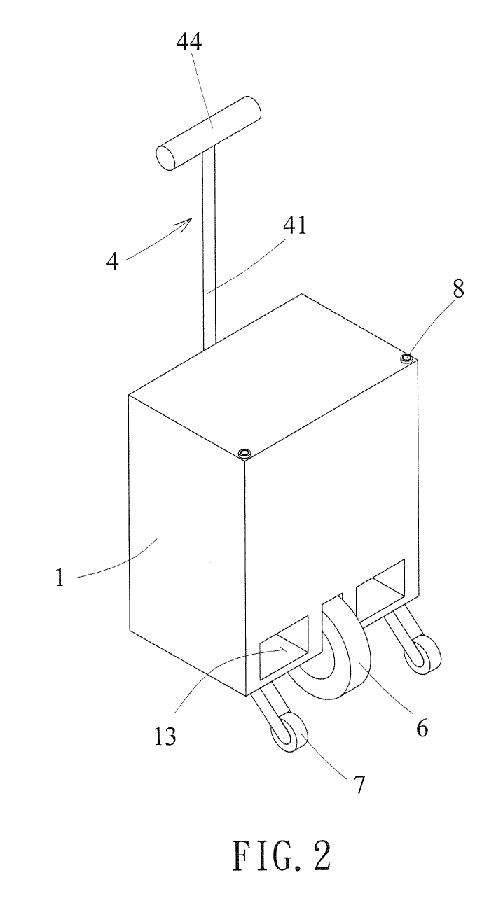

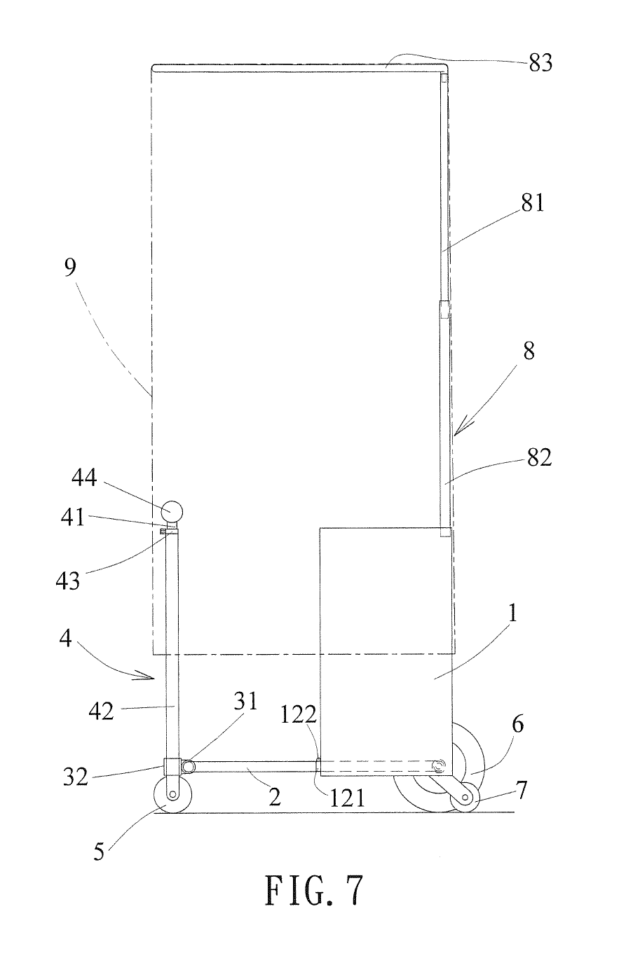

Refer to FIG. 1 and FIG. 2, a luggage scooter of the present invention includes a box 1 with a receiving space, two foot bars 2, an assembly member 3, a vertical rod 4, a front wheel 5, at least one transmission wheel 6, at least one anti-tip wheel 7, two support rods 8, and a tent 9. A receiving slot 11 is arranged at each of two sides of a front surface of the box 1. The luggage scooter further includes a foot rest unit formed by two foot bars 2, a connection rod 21 and a footboard. Each of the two foot bars 2 is mounted to the corresponding receiving slot 11 while one end of each foot bar 2 is pivotally connected to the bottom of the receiving slot 11. A stopper unit 12 is arranged across the receiving slot 11. The stopper unit 12 consists of a holder 121 set on each of two sides of the receiving slot 11 and a n-shaped stopper rod 122. Two pins on two sides of the n-shaped stopper rod 122 are inserted and positioned into the holders 121 on two sides of the receiving slot 11 respectively so as to stop the foot bar 2 mounted in the receiving slot 11. The other end of each foot bar 2 is connected by the connection rod 21 while the footboard is mounted among the two foot bars 2 and the connection rod 21. The assembly member 3 is composed of a sleeve 31 arranged horizontally and a shaft cylinder 32 disposed vertically. The connection rod 21 is mounted in and connected to the sleeve 31 while the shaft cylinder 32 is connected to a front end of the sleeve 31. The vertical rod 4 is moveably mounted into the shaft cylinder 32. The vertical rod 4 is formed by an inner tube 41 and an outer tube 42. The inner tube 41 is mounted into the outer tube 42 so that the vertical rod 4 can be extended or retracted and the height of the vertical rod 4 is adjustable. A fastener 43 is arranged between the inner tube 41 and the outer tube 42 for fixing the height after the vertical rod 4 being adjusted. A handle 44 is disposed on a top end of the inner tube 41 of the vertical rod 4 and the front wheel 5 is connected to the bottom end of the outer tube 42. The transmission wheel 6 is disposed on a center of a bottom side of a rear surface of the box 1 and is connected to a power source that is a wheel hub motor. The power source is connected to a power supply unit. The power supply unit can be a battery in the box 1. The power source is coupled to a drive unit which is a 3-axis sensor. Two foot rest portions 13 are arranged concavely at the rear surface of the box 1, close to the bottom end of the rear surface of the box 1 and located on two sides of the transmission wheel 6 respectively. The anti-tip wheel 7 is set on the bottom side of the box 1 and close to the bottom end of the rear surface of the box 1. In this embodiment, two anti-tip wheels 7 are arranged at the bottom side of the box 1 and close to two lateral sides of the box 1 respectively. Each side of a top surface of the box 1 is mounted with an insertion hole for receiving the support rod 8. The support rod 8 is formed by an outer tube 82 and an inner tube 81 connected to and mounted in the outer tube 82 so that the length of the support rod 8 can be adjusted by extension or retraction. As shown in FIG. 7, a top end of the inner tube 81 of each support rod 8 is connected to each end of a semicircular tent frame 83. The tent 9 is set over the tent frame 83 and the tent 9 covers at least a part of the box 1.

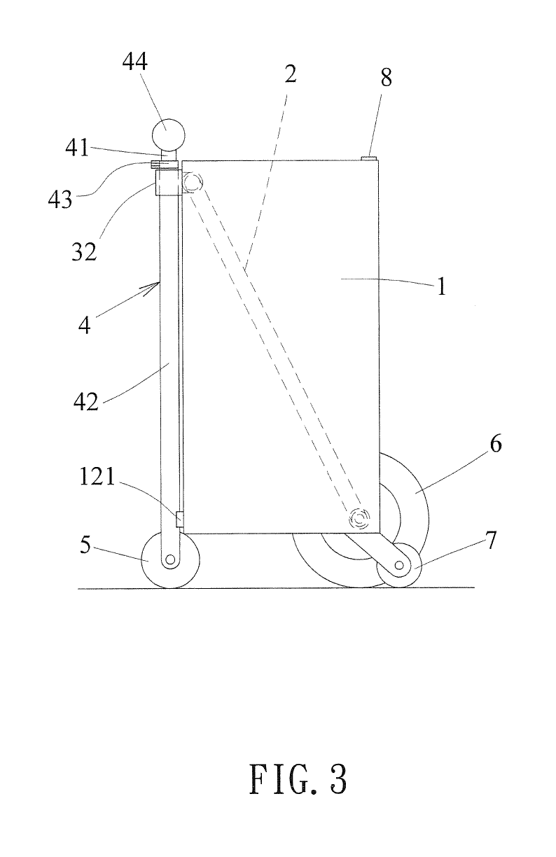

While in use, refer to FIG. 3, the two foot bars 2 are folded and passed through the receiving slots 11 on two sidewalls of the box 1 to be received in the box 1. The stopper units 12 are used to stop and position the foot bars 2 respectively. At the moment, the connection rod 21 that connects the two foot bars 2 is located on an upper part of a front side of the box 1. By the shaft cylinder 32 of the assembly member 3 that is moveably connected to the vertical rod 4, the connection rod 21 is moved to an upper part of the vertical rod 4 to draw the vertical rod 4 against the front side of the box 1 and position the vertical rod 4 on the front side of the box 1. Then the support rods 8 are received in the insertion holes of the box 1. The tent frame 83, the tent 9, and the footboard are set in the receiving space of the box 1. Thus the present invention looks like a general luggage. When users go to school, go work, go shopping, see the doctor, visit friends, go out for business etc., they can put objects they need in the box 1. When users' hands hold the handle 44, they can apply a force to pull or push the device. By the front wheel 5, the transmission wheel 6, and the anti-tip wheels 7 on the bottom thereof, the box 1 and the objects mounted therein are driven to move forward or backward much more easily and conveniently.

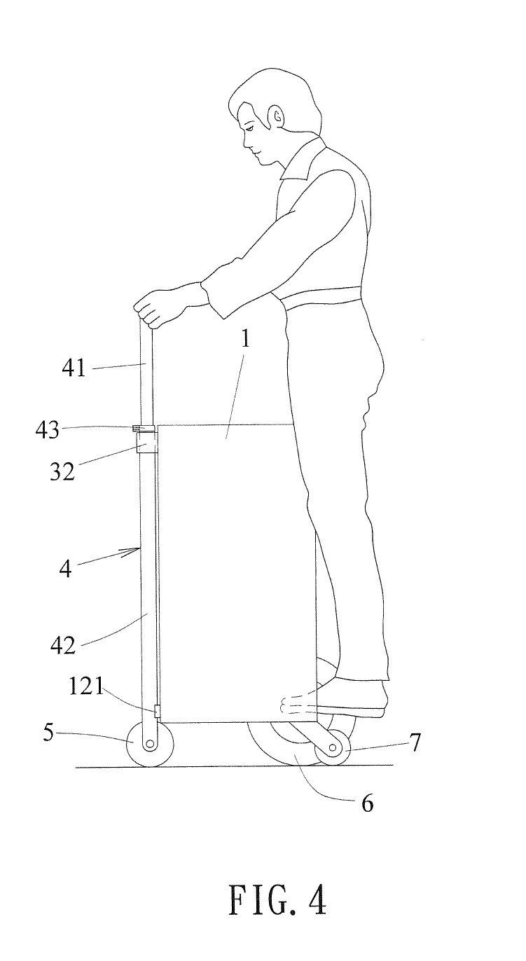

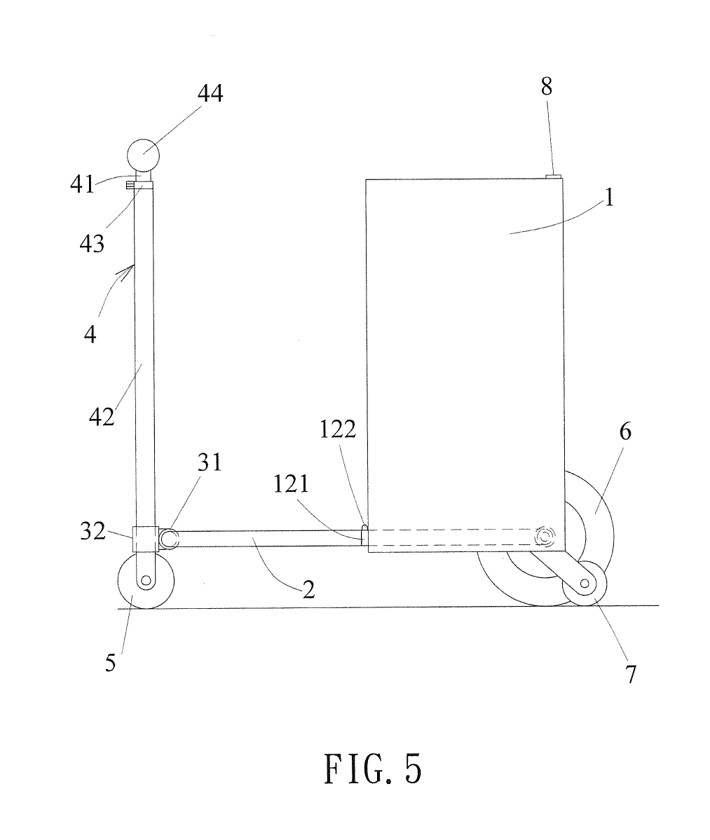

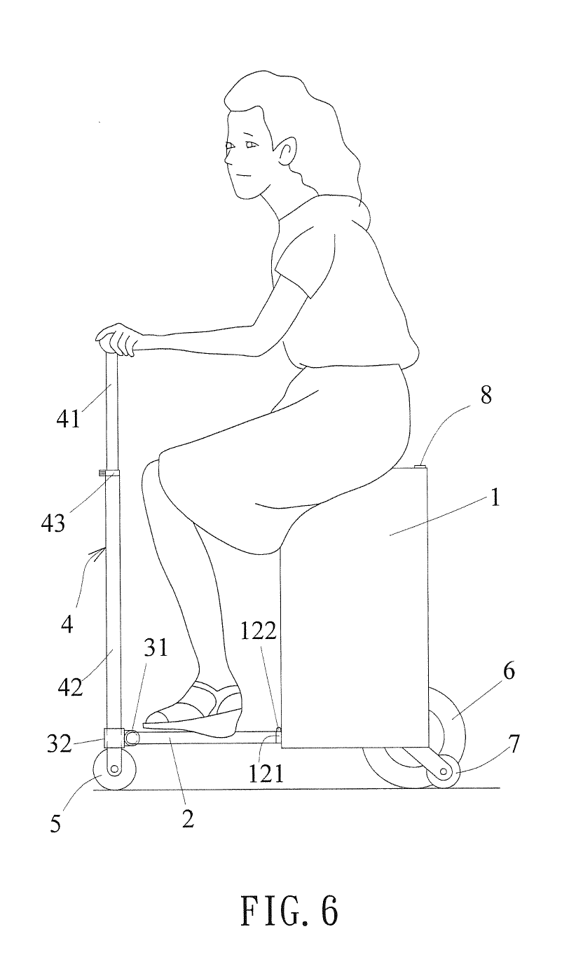

Users may feel tired after walking a certain distance and they can use the present invention to move instead of walking. Refer to FIG. 4, users can stand behind the box 1 and step on the foot rest portions 13 concavely arranged at the rear surface of the box 1. Moreover, users' hands hold the handle 44 on the front end of the device. By the drive unit such as 3-axis sensor, the power source is activated to drive the transmission wheel 6 to move. Thus the present invention and the user standing thereon are further moved. Refer to FIG. 5 and FIG. 6, users can also sit on the box 1 and drive the present invention. The stopper rod 122 of the stopper unit 12 is removed from the holder 121. Then the two foot bars 2 are pulled out from the receiving slots 11 on two sides of the box 1 respectively and lying down to against the bottom of the receiving slots 11. The stopper rod 122 of the stopper unit 12 is inserted into the holder 121 for positioning the foot bars 2. The connection rod 21 between the two foot bars 2 is moved to a lower part of the vertical rod 4 by the shaft cylinder 32 of the assembly member 3 that is moveably connected to the vertical rod 4. The vertical rod 4 is pushed and moved forward to a position in front of the box 1. Thereby users can sit on the box 1 with their hands holding the handle 44 and step on the two foot bars 2. Or the footboard is taken out from the box 1 and set among the two foot bars 2 and the connection rod 21. Users can step on the footboard. Thus users can sit on the box 1 and drive the present invention to move.

Furthermore, users can set up the tent 9 when it is hot or raining. Refer to FIG. 7, the support rods 8 are pulled out from the insertion holes on two sides on the top surface of the box 1. Then the tent frame 83 and the tent 9 are taken out of the box 1. Two ends of the semicircular tent frame 83 are connected to the two support rods 8 respectively. Next the tent 9 is covered over the tent frame 83. The tent 9 is fallen naturally to cover the box 1, the user sit on the box 1, the vertical rod 4, the handle, etc. In the shade of the tent 9, users will not suffer from strong sunlight or heavy rain while driving the luggage scooter outdoors. In addition, the direction of the semicircular tent frame 83 can be adjusted according to the posture of the user such as standing or sitting. When the user is standing on the luggage scooter, the semicircular tent frame 83 is placed at the position that is over a rear side of the box 1. Thus the user can be covered by the tent 9 on the semicircular tent frame 83. When the user is sitting on the box 1, the semicircular tent frame 83 is placed at the position that is over a front side of the box 1 for covering the user, as shown in FIG. 7. Thereby the user feels more comfortable while driving the present invention to move no matter he is standing or sitting.

In summary, the present invention features on simple structure, easiness in folding and unfolding, and light weight. After being folded, the luggage scooter becomes a luggage with a small volume and used for mounting objects. Moreover, users can carry the luggage with them conveniently. When users intend to move a long distance, they can sit on the present invention in public transport vehicles. After getting off the public transport vehicle, users can also use the present invention as a means of transportation for short distances. There is no need to take other transport means such as taxi or bus. The present invention provides users a more convenient transport means. While driving the present invention, users' belongings can be mounted in the box 1 and users don't need to carry other bags with them. Thus users feel more comfortable and the driving safety is improved. Users can set charging devices such as chargers, extension cords, etc in the box for charging the power supply unit when the power is low.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A luggage scooter comprising:
a box with a receiving space therein;
a moveable and foldable foot rest unit disposed on a front surface of the box;
a vertical rod arranged at a front end of the foot rest unit and disposed with a handle thereon;
a front wheel set on a bottom end of the vertical rod;
at least one transmission wheel that is disposed on a bottom side of the box and connected to a power source while the power source is coupled to a power supply unit in the box and connected to a drive unit; and
at least one anti-tip wheel disposed on a bottom surface of the box.

2. The luggage scooter as claimed in claim 1, wherein a receiving slot is arranged at each of two sides of the front surface of the box; the foot rest unit includes two foot bars which are received in the receiving slots respectively, and a connection rod; one end of the foot bar is pivotally connected to a bottom of the receiving slot while the other end of each of the foot bars is connected to the connection rod.

3. The luggage scooter as claimed in claim 2, wherein an assembly member is disposed between the front end of the foot rest unit and the vertical rod; the assembly member includes a sleeve placed horizontally and a shaft cylinder set vertically; the connection rod of the foot rest unit is mounted in and connected to the sleeve while the shaft cylinder is connected to a front end of the sleeve; the vertical rod is moveably mounted into the shaft cylinder.

4. The luggage scooter as claimed in claim 2, wherein a stopper unit is disposed across the receiving slot and used for stopping the foot bar correspondingly.

5. The luggage scooter as claimed in claim 4, wherein the stopper unit includes two holders set on two sides of the receiving slot respectively and a n-shaped stopper rod having two pins on two sides thereof being inserted and positioned into the holders respectively.

6. The luggage scooter as claimed in claim 1, wherein the vertical rod includes an inner tube and an outer tube connected to each other so that the vertical rod is able to be extended or retracted; the handle is disposed on a top end of the inner tube while the front wheel is arranged at a bottom end of the outer tube.

7. The luggage scooter as claimed in claim 1, wherein a fastener is arranged between the inner tube and the outer tube.

8. The luggage scooter as claimed in claim 1, wherein the transmission wheel is located at a center of the bottom side of the box while two anti-tip wheels are disposed on two sides of the transmission wheel respectively.

9. The luggage scooter as claimed in claim 1, wherein two foot rest portions are arranged concavely at a rear surface of the box.

10. The luggage scooter as claimed in claim 1, wherein an insertion hole for receiving a support rod is mounted on each of two sides of a top surface of the box; the luggage scooter further includes a tent and a tent frame; two ends of the tent frame are connected to the two support rods respectively while the tent is set over the tent frame and covering at least a part of the box.

11. The luggage scooter as claimed in claim 10, wherein the support rod includes an inner tube and an outer tube connected to each other so that the support rod is able to be extended or retracted; each of the two ends of the tent frame is connected to a top end of the inner tube of the support rod.

12. The luggage scooter as claimed in claim 1, wherein the drive unit is a 3-axis sensor.
